(19) United States
(12) Patent Application Publication
(10) Pub. No.: US 2012/0062781 A1
(43) Pub. Date: Mar. 15, 2012

(54) Camera System and Method for Adjusting a Camera System

(76) Inventor: Karl Gfeller, Langwiesen (CH)

(21) Appl. No.: 13/229,073

(22) Filed: Sep. 9, 2011

Related U.S. Application Data
(60) Provisional application No. 61/381,127, filed on Sep. 9, 2010.

(51) Int. Cl. H04N 5/225

(52) U.S. Cl. 348/335; 348/E05.024

(57) ABSTRACT

On a camera, the lens board (1) and the imager holder (10) are connected to one another through linear actuators (31). This allows the lens plane (EO) resp. the image plane (EB) to pivot around selectable axes lying accordingly in said planes. As a result, it affords the possibility with a camera and for a selected scene plane to easily comply with the Scheimpflug principle.

The present invention relates to a camera system having a lens board, onto which there is a lens determining a lens plane, and having an imager holder determining a film plane, wherein the lens board and the imager holder are placed in adjustable manner relative to each other and are operatively connected to one another by means of controlled drivers so that they can be displaced in translation in the direction of the focusing axis of the lens relative to one another.

Such camera systems are known for example from WO95/15054 and from CH666756.

In both previously known camera systems, the lens board and the imager holder can be pivoted in relation to the tilting axis of the system base resp. camera body.

It is an aim of the present invention to improve the relative mobility of the lens board and of the imager holder in order to thus achieve considerable advantages as regards the adjustability of the camera system as compared with systems of the mentioned type known from the prior art.

For this purpose, the camera system according to the invention has a lens board that can pivot around a lens plane axis lying in the lens plane and whose position in the lens plane can be chosen at least across a wide range and/or it is the imager holder that can be pivoted around a film plane axis lying in the image plane, wherein its position in the image plane can be chosen at least across a wide range.

Because of the possibility afforded by the inventive camera system of pivoting at least one of the mentioned standards relative to one axis that can be chosen at least across a wide range in the corresponding plane, being the lens plane for the lens board and the image plane for the imager holder, and this without any further additional modification of the relative position of said planes being required, the inventive camera system can achieve a very high flexibility as regards the relative movements of the lens plane and image plane that are to be performed. Furthermore, it can be seen that because of the possibility of choosing the relevant tilting axis, it is possible to do without pivoting axes that are fixed to the system base resp. camera body, wherein this however affords the advantage of being to the greatest possible extent independent from the mechanical construction of the system base resp. of the camera body.

As mentioned, the aforesaid pivoting movement around the corresponding selectable axis in the inventive system can also be achieved without additional modification of the relative position of both planes.

In one embodiment of the inventive camera system, the lens board or the imager holder is mounted on the system base resp. camera body. Accordingly, the imager holder resp. the lens board is mounted onto the lens board resp. imager holder.

Thus one of the standards, namely the one that is mounted on the system base resp. camera body, constitutes the basis for supporting the other standard. One of the two standards is thus mounted onto the other standard and its storage is mostly independent from the configuration of the system base resp. camera body.

By system base one should understand the system on which, for a view camera in particular, the imager holder as well as the lens board are mounted. For a view camera, this system can consist for example of a tripod, as represented for example in CH666756. The system base, in the case of a compact camera, is the camera body.

In one embodiment of the inventive camera system, the controlled drivers include linear actuators, that are preferably mounted through ball and socket joints and/or cardan joints on the one hand onto the lens board and on the other hand onto the imager holder. The relative movements between the lens board and the imager holder are thus achieved through means that operate between the aforesaid standards, which results to the greatest extent in independence from the construction of the system base resp. camera body.

In a further development of the inventive camera system, the joints of the linear actuators form with either a lens board or an imager holder an n-angle and, accordingly, with the imager holder or lens board an m-angle. A good embodiment is given when the m=n/2. Each terminal joint of a linear actuator facing this standard defines an angle on the lens board or on the imager holder and, accordingly, on the other standard—imager holder or lens board—two terminal joints facing the latter standard define an angle together, i.e. at least approximately united structurally. It is useful to provide an even number of linear actuators, preferably six.

In a further development of the aforesaid inventive camera system, the mentioned n and n/2 angles form regular polygons.

The aforesaid linear actuators include in a further embodiment of the camera system spindle drivers. Furthermore, the mentioned spindle drivers are preferably driven with an electric motor, preferably with a direct current motor or stepping motor. Furthermore, position sensors are further preferred, preferably angular position sensors, even more preferably absolute angular position sensors operatively connected with the spindle drivers. By means of the mentioned position sensors, it is possible to determine the momentary spindle driver extension length and further to use, this information defining the relative position of the standard in question.

According to the embodiments so far, the lens board of the inventive camera system can be moved relative to the imager holder. If the inventive camera system is a view camera wherein the imager holder and lens board are connected with a bellows, as represented for example in CH666756, it is then possible to achieve the mentioned relative movement by moving the imager holder and/or by moving the lens board. If on the contrary the camera system is a compact camera or more generally a camera with a lens fixed to the body or a lens that can be moved only in a translation movement, the mentioned relative movement is achieved by moving merely the imager holder.

In a further embodiment of the inventive camera system, it includes a scene point selection unit as well as a programmed computing unit. The inputs of the computing unit are operatively connected with the outputs of the scene point selection unit and the outputs of the computing unit are operatively connected with the control inputs for the drivers.

The scene point selection unit makes it possible to select from an image of the scene freely selectable points resp. areas. On the basis of the information entered into the programmed computing unit about the selected scene points, the programmed computing unit, as will be explained, will issue control information on the output side, by means of which the drivers can be driven for a pre-settable setting of the camera system.

The inventive camera system affords considerable advantages as regards the adjustability of the camera system.

In the context of these general advantages, one advantageous result is that the camera system setting can be performed simply so that the Scheimpflug principle can be complied with, as will be explained hereinafter.

For example, the mentioned document CH666756 describes in detail when the Scheimpflug principle is observed. Reference is made in said document to explanations of these principles and how they can be complied with in a camera system by focusing the image point of three scene points. Basically, a desired scene plane is then reproduced with maximum focus when the scene plane, the lens plane and the image plane intersect in a common line. The scene plane reproduced in focus is often called focal plane. The nodal plane of the lens is the lens plane. Most lenses have two nodal planes—and thus two lens planes, on the subject side and on the image side. The Scheimpflug principle states more accurately that the scene plane should intersect with the lens plane on the subject side at a same distance from the axis of the lens as the image plane intersects with the lens plane on the image side and that both intersecting lines should be parallel to one another. In doing so, both intersecting lines should be on the same side of the mentioned axis, i.e., in terms of space, in the same quadrant relative to this axis.

The inventive camera system makes it possible to comply in optimum fashion with the Scheimpflug principle for any freely chosen scene plane. To this effect, the mentioned programmed computing unit in one embodiment of the inventive camera system is programmed in such a manner that the drivers are controlled by entering, into the scene point selection unit, three different scene points so that the three image points of the scene points are simultaneously reproduced in focus on the image plane.

In one embodiment of said camera systems, the computing unit is programmed in such a manner that the drivers are controlled by entering, into the scene point selection unit, a first of the three scene points so that the lens board and the imager holder are displaced in a translation movement along the focal axis of the lens in a relative position to one another in which the image of the first selected scene point is represented in focus in the image plane.

In a further embodiment of said camera system, the computing unit is programmed in such a manner that the drivers are controlled by entering, in the scene point selection unit, the second of the three scene points so that the lens board is pivoted around a first lens plane axis, running through the lens nodal point on the image side and at least approximately vertical to the plane given by the lens nodal point on the image side as well as the first and second image point of the first and second scene point, into a position in which the second image point is represented in focus in the image plane.

In one embodiment of said camera system, the computing unit is further programmed in such a manner that the drivers are controlled by entering, in the scene point selection unit, the third of the three scene points so that the lens board is pivoted around a second lens plane axis, that is formed at least approximately by the intersecting line ahead of the true lens nodal plane on the image side and the plane given by the first and second image point and the lens nodal point on the image side, into a position in which the third image point is also represented in focus in the image plane.

In the latter embodiments mentioned above of the camera system, the lens board is pivoted around the corresponding lens plane axis. This process is consequently suitable for view cameras but not for compact cameras with a lens fixed to the body or a lens that can be built in and be moved at most in a translation movement along the direction of the focal axis.

For the latter cameras, the execution of one of the standards in pivotally movable manner is limited to the imager holder. In particular, in the context of the latter type of camera system, a further embodiment of the inventive camera system arises wherein the computing unit is programmed in such a manner that the drivers are controlled by entering, in the scene point selection unit, the second of the three scene points so that the imager holder is pivoted around a first image plane axis, running through the first image point of the first scene point and at least approximately vertical to the straight line given by the first and the second image point of the first and second scene point, into a position in which the second image point is represented in focus in the image plane. In this case, as mentioned above, the focusing of the image point of the first scene point continues to be achieved by controlling the drivers in such a manner that the lens board and the imager holder are displaced in a translation movement in the direction of the lens axis in a relative position to one another.

In a further embodiment, the mentioned computing unit is further programmed in such a manner that the drivers are controlled by entering, in the scene point selection unit, the third of the three scene points so that the imager holder is pivoted around a second image plane axis running at least approximately through the first and second image point of the first and second scene point, into a position in which the third image point is also represented in focus in the image plane.

Furthermore, the present invention relates to a method for adjusting a camera system, by means of which the Scheimpflug principle can be complied with for a selectable scene plane. To execute this method, the inventive camera system mentioned initially is particularly suited.

According to the inventive method, by a relative translation movement of the lens board and of the imager holder of the camera system, the image of a first, freely selectable scene point is focused in the image plane. Then, in a first embodiment of the mentioned method, through a first pivoting movement of the lens board around a first lens plane axis in the lens plane, the image of a second, freely selectable scene point is focused in the image plane without affecting the image of the first scene point already focused. Then, through a second pivoting movement of the lens board around a second lens plane axis in the lens plane, the image of a third, freely selectable scene point is focused in the image plane, without affecting the focus of the first and second scene points in the image plane.

In a second embodiment of the inventive method, through a first pivoting movement of the imager holder around a first image plane axis in the image plane, the image of a second, freely selectable scene point is focused without affecting the focus resp. the image of the first scene point whose focus has already been set through the mentioned relative translation movement.

Then, through a second pivoting movement of the image holder around a second image plane axis in the image plane, the image of a third, freely selectable scene point is focused, without affecting the focus of the first and second scene points in the image plane.

In a first variant of the first embodiment of the inventive method, the mentioned lens plane axis is selected so that it runs through the lens nodal point on the image side and is at least approximately vertical to the plane given by the lens nodal point on the image side as well as the first and second image point of the first and second scene point.

In a further variant, still of the first embodiment of the inventive method, the second lens plane axis is selected so that it is formed at least approximately by the intersection line from the current lens nodal plane on the image side and the plane given by the first and second image point and the lens nodal point on the image side.

In a further variant of the second embodiment of the inventive method, the first image plane axis is selected so that it runs through the first image point of the first scene point and is at least approximately vertical to the straight line given by the first and second image point of the first resp. second scene point.

In a further variant of the second embodiment of the inventive method, the second image plane axis is selected so that it runs through the first and second image point of the first resp. second scene point.

In the method according to the invention in all its variants and embodiments, the locations of the lens plane axis or image plane axis at least are determined automatically on the basis of the scene point indications, preferably also the pivoting movements and/or the relative translation movement.

Hereinafter, the invention will be explained in more detail by way of example on the basis of figures, which show:

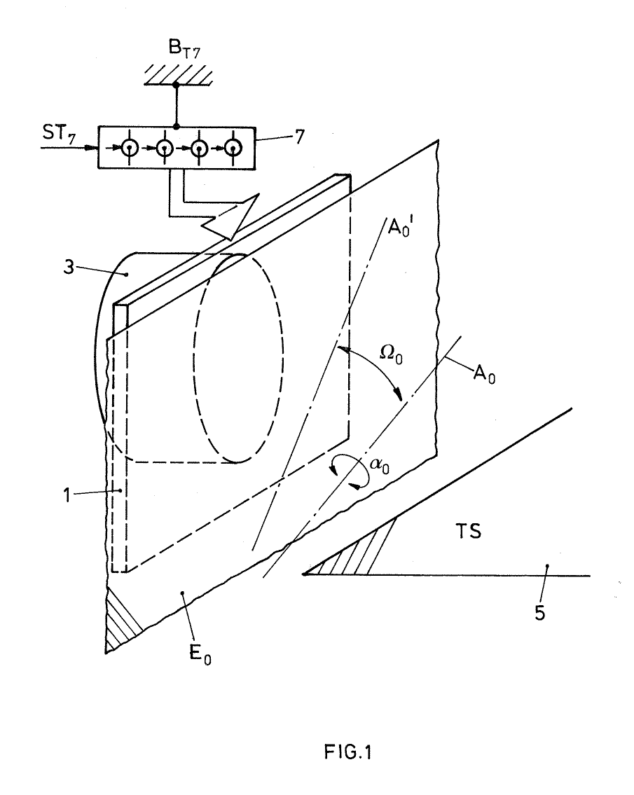

FIG. 1 in perspective view, schematically and in a simplified manner, part of an inventive camera system, with which a first embodiment of the inventive method is executed;

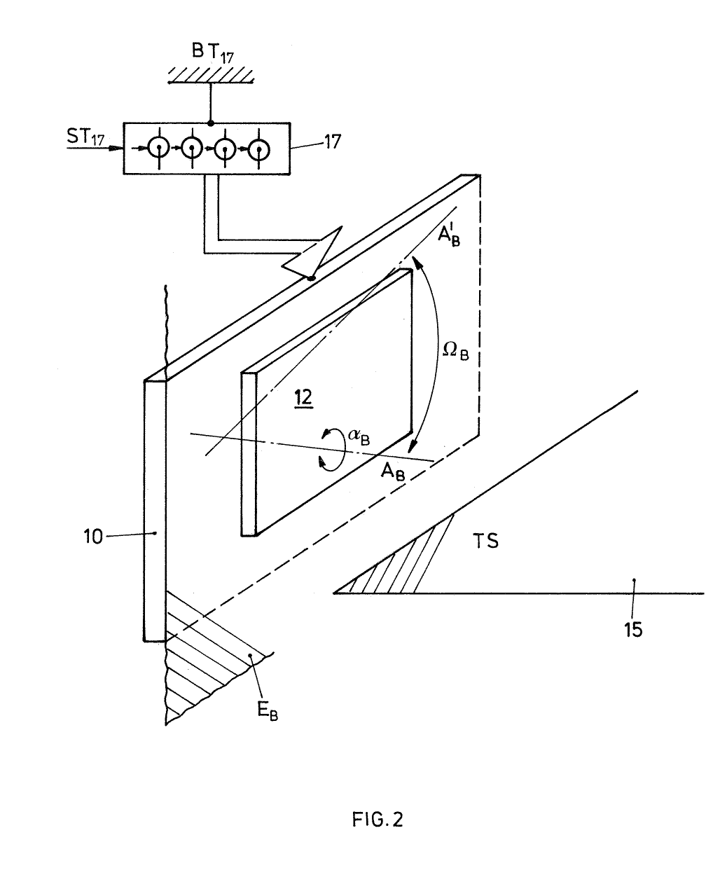

FIG. 2 in a representation analogous to that of FIG. 1, a further part of an inventive camera system, with which the inventive method in a second embodiment is executed;

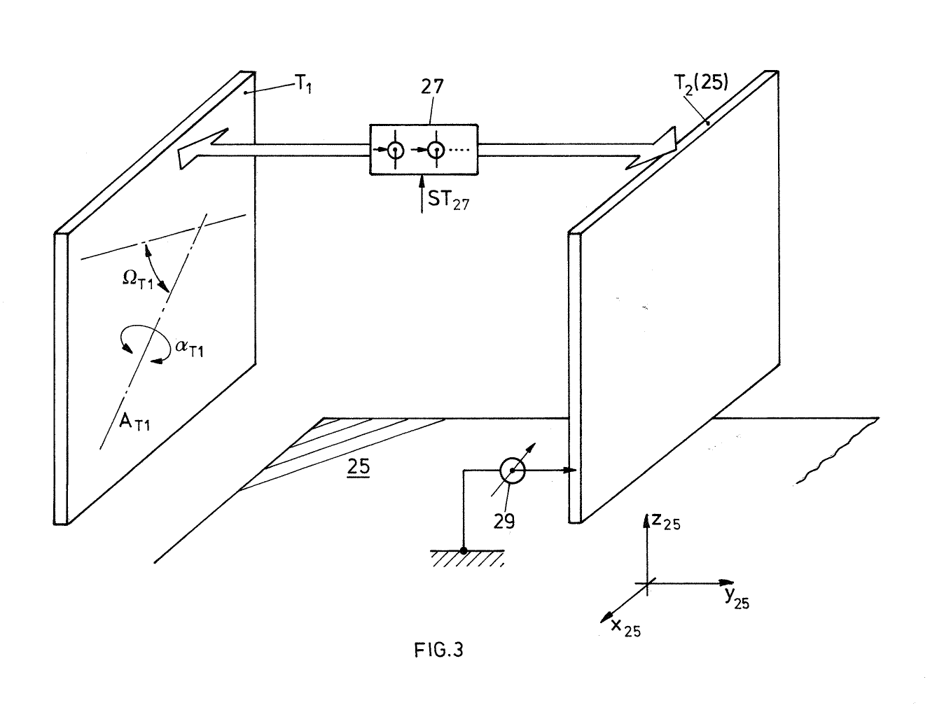

FIG. 3 in a representation similar to that of FIGS. 1 and 2, a further embodiment of the inventive camera system, with which the inventive method is executed;

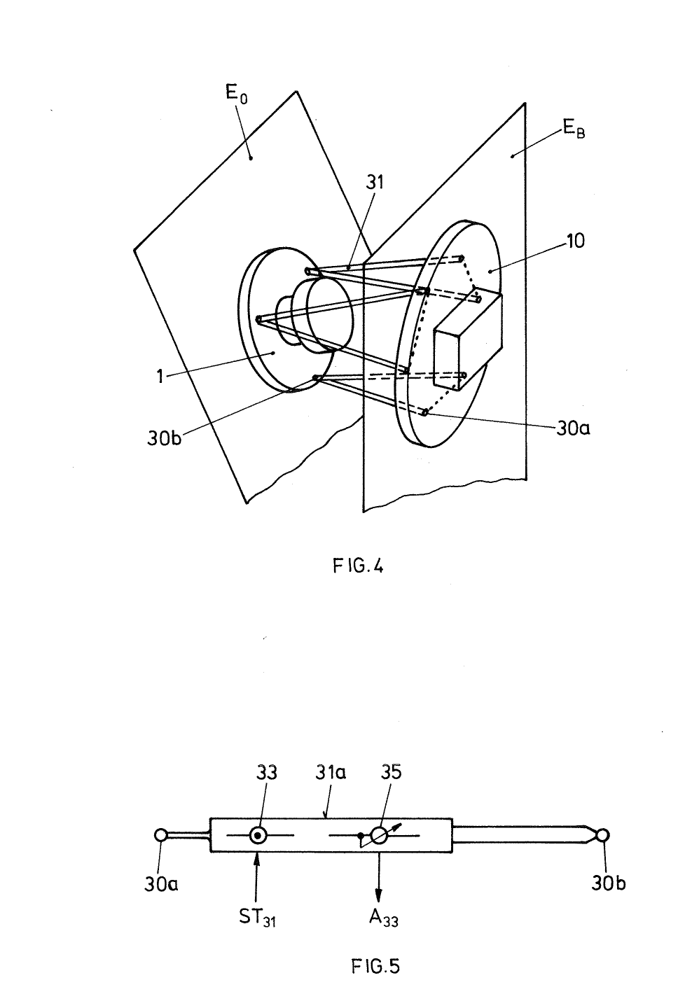

FIG. 4 in perspective view, schematically and in a simplified manner, the connection of a lens board and of an imager holder in an inventive camera system;

FIG. 5 schematically, an embodiment of a linear actuator, as used for example in the camera system according to FIG. 4;

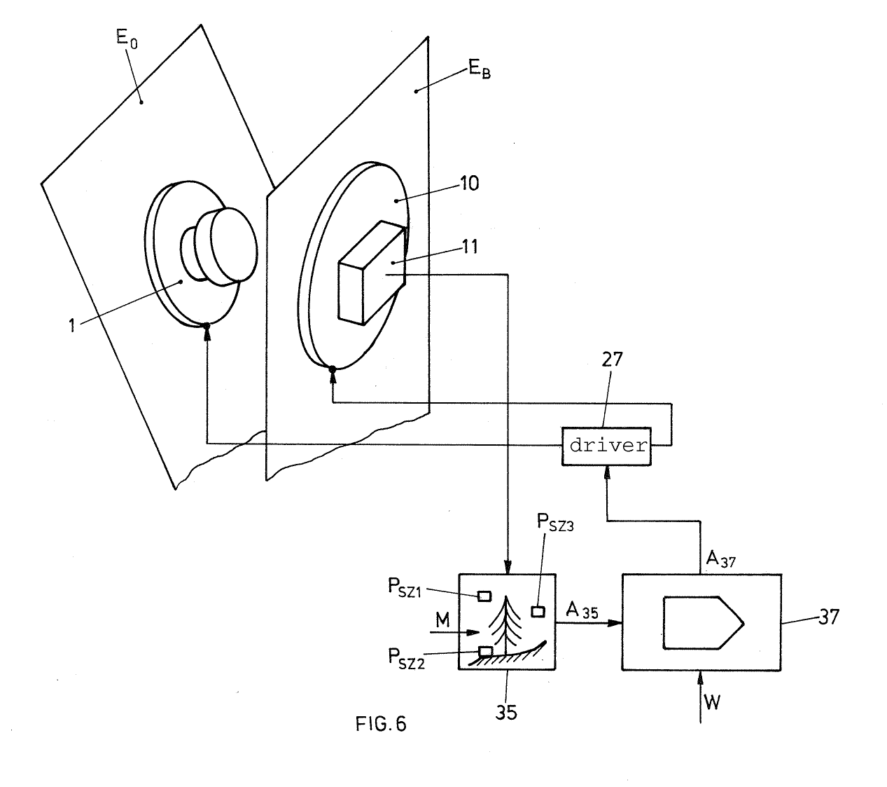

FIG. 6 on the basis of an inventive camera system as represented in FIG. 4, a further embodiment with which the inventive method is also executed;

FIG. 7 schematically and in perspective view, the controlled position arrangement of image plane and lens plane in an inventive camera system in order to comply with the Scheimpflug principle according to an inventive method in a first embodiment, and

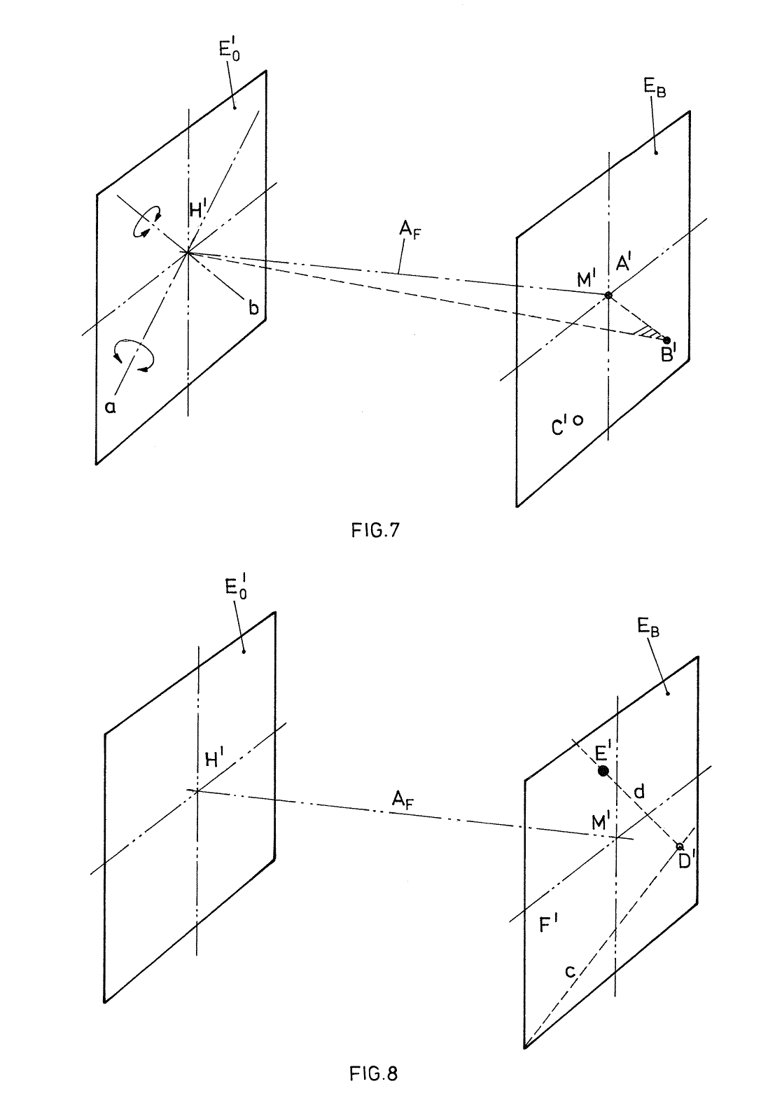

FIG. 8 in a representation analogous to that of FIG. 7, the position arrangement of image plane and lens plane in a further embodiment of the inventive camera system resp. according to the inventive method in a second embodiment.

FIG. 1 represents in a perspective view, purely schematically and in a simplified manner, part of an inventive camera system. A lens 3 is mounted on a lens board 1 of the inventive camera system. The lens 3 mounted on the lens board 1 defines the position of a lens plane E_{O}. The expression ‘lens plane’ designates one of the usually two nodal planes defined for a lens. The lens plane E_{O} considered for the moment from a general viewpoint can thus correspond to either the lens nodal plane on the scene side or on the image side.

A system base for the camera system is furthermore represented schematically with reference number 5 in FIG. 1, being the camera body in the case of a compact camera and, for a view camera, the system onto which the lens unit on the one hand and the imager unit on the other hand are mounted, usually connected with a bellows.

As furthermore represented in FIG. 1, the lens board 1 is operatively connected by means of a driver array 7, represented with ST₇, with a reference system B_{T7}. As will also be seen, the reference system B_{T7} for the driver array 7 is preferably not identical with the system base 5.

With the aid of the driver array 7, which acts on the lens board 1, the lens plane E_{O} is pivoted about a lens plane axis A_{O} to a degree α_{O} that is predetermined by the control ST₇ for the driver array 7. Furthermore, the length of the axis A_{O} in the lens plane E_{O} can be chosen freely and is not dictated by the corresponding control ST₇ of the driver array 7. The ability to select and thus vary the position of the tilting axis Aₒ is represented diagrammatically in FIG. 1 with A_{O}′ and the displacement double arrow Ω_{O}. Thus, through the control ST₇ of the driver array 7 determines on the one hand the position Ω_{O} of the axis α_{O} in the lens plane E_{O} and additionally the value α by which the lens plane E_{O} is to be pivoted around said axis A_{O}. The pivoting movement and the selection of the axis position are performed through the controlled movement of the lens board 1 by means of the driver array 7. A further embodiment of an inventive camera system is represented in FIG. 2 in a representation analogous to that of FIG. 1. An imager holder 10 holds an imager 12. The latter defines the image plane E_{B}. The imager holder 10, in a manner fully analogous to the lens board 1 according to FIG. 1, is operatively connected relative to a reference system BT_{T7} with a driver array 17 controllable by means of inputs ST₁₇. The reference number 15 designates the system base of the camera system resp. the camera body. By means of the driver array 17, the imager holder 10 is pivoted around a freely chosen—Ω_{B}—image plane axis A_{B} to a degree α_{B} according to the particular requirements.

According to the descriptions of FIG. 1 resp. 2, it can be seen that in the inventive camera system, the relative position of one of the planes, lens plane E_{O} and image plane E_{B}, can at any rate be set by pivoting the mentioned one plane E_{O} and/or E_{B} by a respective selectable axis A_{O}, A_{B} in the corresponding plane, whose position in the mentioned plane E_{O} and E_{B} can be chosen freely Ω_{O}, Ω_{B}.

On the basis of the embodiments according to FIGS. 1 and 2, a further embodiment of an inventive camera system is represented in FIG. 3, wherein notably a particular embodiment of the driver array is addressed. In FIG. 3, one of the standards, according to FIG. 1 or 2 a lens board 1 or an imager holder 10, is identified by the reference sign T₁ and, accordingly, the other of the two standards addressed in FIG. 1 resp. 2, i.e. accordingly the imager holder 10 or the lens board 1, with T₂. The standard T₂, which is determined in the corresponding plane E_{O} or E_{B} (not drawn any longer in FIG. 3), is mounted as reference system relative to the system base 25 of the camera system. As is represented schematically with the adjusting member 29, the standard T₂ can in this respect be mounted in a fixed manner or in a spatially freely adjustable manner, depending on the requirements in a translation movement in one or several of the coordinate directions X₂₅, Y₂₅, Z₂₅ resp. in a pivoting manner around one or several of the mentioned axes. As indicated with T₂ (25) in FIG. 3, the reference coordinate system relative to which the standard T2 is positioned on a case-by-case basis is at any rate the system base 25 of the camera system.

As for the standard T₁, it can be moved and positioned through the driver array 27. The driver array 27 for the standard T₁ acts between the standard T₂—if required fixed to the system base—and the standard T₁. Thus, for a freely adjusted position of the standard T2 relative to the system base 25, the relative position of the standard T₁ to T₂ can be set through the driver array 27. In this respect, the pivoting axes AT₁ can be freely selected as to their position by correspondingly controlling the driver array 27 and, additionally, the degree to which the plane allocated to the standard T1, the image plane E_{B} or the lens plane E_{O}, is pivoted around AT₁.

In FIG. 4, a further embodiment based on the example of embodiment of an inventive camera system represented schematically in FIG. 3 is represented schematically and in a simplified manner. In this respect, the lens board 1 and the imager holder 10 are coupled to one another as respective standards T₁ and T₂ according to FIG. 3 through linear actuators 31 that execute the driver array 27 according to FIG. 3. Each of the linear actuators 31 is linked 30a, 30b terminally, such as by means of ball and socket joints or cardan joints, to the lens board 1 and imager holder 10. A possible embodiment of the linear actuators 31 is represented more simply in FIG. 5. The linear actuator 31a according to FIG. 5 is made as spindle drivers. On the one hand, it has a joint part 30ₐ, on the other hand a joint part 30_{b}, by means of which, according to FIG. 4, it is mounted in articulated manner on the one hand onto the lens board 1 and on the other hand onto the imager holder 10. The spindle driver 31a has an integrated motorized driver 33, preferably motorized electrically. In this respect, the driver 33 is preferably executed as stepping motor or direct current motor. As represented schematically in FIG. 5, the driver 33 is controlled through a control input ST₃₁.

Furthermore, a position sensor 35 is provided, preferably integrated in the linear actuator, according to FIG. 5 in the spindle driver 31, preferably comprising an angular position sensor, preferably comprising an absolute angular position sensor. Information about the momentary extension length of the linear actuator, i.e. about the distance of the joint parts 30a and 30b, can be retrieved at an output A₃₃. By controlling each of the provided linear actuators 31 according to FIG. 4, any relative position between the mentioned standards 1, 10 can be freely selected, limited practically only by structural factors. There are six linear actuators 31 in FIG. 4, which is a good embodiment. The linear actuators are furthermore joined to a standard, according to FIG. 4 to the imager holder 10 by way of example, so that the joints form an even-numbered n-angle, where n is an even number, this number being six according to FIG. 4. Furthermore, this n-angle in a good embodiment forms at least approximately a regular polygon, i.e. its side lengths and inside angles are equivalent.

FIG. 4 shows a good embodiment of the linear actuator arrangement. Furthermore, both standards can form, with the joints of the linear actuators, polygons with a same number of corners or even, by consolidated assembly of the joints of only certain linear actuators, the number of angles of the polygon of the one standard can be freely chosen to be smaller than that of the other standard. Furthermore, the polygons defined by the joints to the respective standards can also be executed to be not approximately regular, i.e. with the same side length and same inner angles. It is however advantageous for the linear actuators of one of the standards according to FIG. 4 to be coupled together to the lens board 1, as they need to travel merely required lengths and do not have to travel extremely accurate time-dependent trajectories that are synchronized with the trajectories of the other linear actuators.

On the other standard—1—the joint parts of two linear actuators 31 according to FIG. 4 are coupled respectively together so that the mentioned joints form there a n/2-angle, i.e. a polygon with half the number of angles as compared with the polygon at the other standard. In the case of a hexahedron at one standard—10—a triangle will consequently be formed as a result on the other standard. The linear actuators 31 used are preferably all the same.

With respect to the fixed assembly of the system represented in FIG. 4 onto the system base of the camera system resp. onto the camera body, the following applies:

In the case of a view camera, the imager holder 10 according to the standard T₂ from FIG. 3 can be mounted either onto the system base or onto the lens board 1. In the case of a camera in which the lens is permanently installed, such as a compact camera, the lens holder is mounted in relation to the camera body, if necessary so that it can be moved in translation in the direction of the focal axis, and the imager holder 10 is operatively connected with the lens holder 1 through the driver array, i.e. the linear actuators 31, for performing whatever tumbling motion is desired as represented in FIG. 4. Taking as a starting point for example in FIG. 4 a lens board 1 mounted in relation to the system base, it is possible in this connection, by means of the driver array 27 formed by the linear actuators 31, to pivot the imager holder around any axis in the image plane E_{B} to any desired degree. This is possible by respectively controlling accordingly the driver array 27 provided, namely in FIG. 4 the six linear actuators 31 provided.

On the basis of the general representation of the examples of embodiment according to FIG. 3 and in a representation analogous to that of FIG. 4, a further embodiment of the inventive camera system is represented schematically and in a simplified manner in FIG. 6. The driver array 27 in FIG. 6 is represented schematically in analogous manner to FIG. 3 and is executed in a good embodiment, as was explained on the basis of FIG. 4 resp. 5.

According to FIG. 6, a scene point selection unit 35 is provided for the inventive camera system. The camera use can select there the points resp. areas of the scene to be photographed. This can occur in any known way and manner whatsoever, such as the displacement of marking points on an optical viewfinder or on a viewfinder screen on which the scene image is displayed by opto-electronic reconversion, on a computer monitor etc. By marking a selected scene point, the corresponding position coordinates of the image point corresponding to the selected scene point in the image plane E_{B} are known at any rate. In FIG. 6, the scene point selection unit 35 by way of example is operatively connected on its input side with the outputs of the imager unit 11.

By a manual input M, whether this is by entering the coordinates, a touch pad input, a displacement input etc., a scene point P_{SZ} is selected on the scene point selection unit 35. At outputs A₃₅, the data identifying the selected point P_{SC} are issued by the scene point selection unit 35 and forwarded to a programmed computing unit 37. The programmed computing unit 37 determines the data for controlling the driver array 27, which are issued at the computer unit output A₃₇ and by means of which the driver array 27 is controlled. On the basis of the selection of one or several image points P_{SZ} on the scene point selection unit 35, the computing unit 37 determines program-controlled driver control signals so that selected settings of the lens plane and image plane are automatically adjusted, according to the indicated desired effects to be achieved, as represented schematically with the selection input W in FIG. 6. The possibilities of movements of the lens board 1 relative to the imager holder 10 afford a plurality of possibilities, desired photographic effects performing a corresponding relative positioning of the standards. In this respect, it is particularly advantageous that at least one of the two standards can be pivoted directly in any freely selectable axis in the associated plane, be it the lens plane or the image plane.

The camera system described so far makes it in particular possible to select any scene plane that is focused in the image plane E_{B} whilst complying with the Scheimpflug principle.

With the aid of FIG. 7, a first embodiment of this inventive method by means of an inventive camera system will be explained. FIG. 7 illustrates the lens plane on the one hand and the image plane E_{B} on the other hand. Of the two lens planes according to the lens nodal planes, the one on the image side, i.e. E′_{O}, is preferably used. On the scene point selection unit 35, with reference to FIG. 6, a first scene point P_{SZ1} is selected within the presented scene. On the basis of the scene point information that is conveyed to the computing unit 37, the latter determines by means of its programming the translation movement displacement between the lens board 1 and the imager holder 10 in order to achieve that in the image plane E′_{B}, the selected scene point P_{SZ1} is reproduced in focus as image point A′. Although in FIG. 7 the image of a central scene point is represented in the image plane as first image point A′, it must be stressed that any scene point P_{SZ1} in the scene can be selected that is focused through the mentioned relative translation movement of the lens board 1 and imager holder 10 in the image plane E_{B} to A′. With reference to FIG. 6, the computing unit 37 is consequently programmed in such a way that a first scene point P_{SZ1} selected on the scene point selection unit 35, is focused in the image plane E_{B} through a relative translation movement of both standards in the direction of the focal axis A_{F} of the lens, by controlling the driver array 27.

As a second step, a second scene point P_{SZ2} is selected on the scene point selection unit 35 according to FIG. 6. By pivoting the lens plane E_{O}′ by a first lens plane axis a that lies in the lens plane E_{O}′, the second selected scene point P_{SZ2} in the image plane E_{B} is focused to the image point B′. In this respect, the scene point to be focused second can also be freely selected on the selection unit 35. The position of the first lens board tilting axis a is such that it on the one hand runs through the lens nodal point H′ on the image side and on the other hand is at least approximately vertical to the plane defined by the mentioned nodal point H′, the image A′ of the first selected scene point and the image B′ of the second selected scene point.

By pivoting the lens plane E_{O}′ around an axis that runs through the lens nodal point H′ on the image side, the first selected image point A′ on the image plane E_{B} remains reproduced in focus and does not shift. Reference is made here for example to Bergmann-Schaefer, Lehrbuch der Experimentalphysik [Textbook of Experimental Physics], vol. III, Optics, p. 95, published by Walter de Gruyter, Berlin & New York, 1978, 7^{th} edition.

Furthermore, since the tilting axis a in the lens plane does not necessarily have to be exactly a normal line to the plane, formed by the nodal point H′, the image A′ and the image B′, but for this selection operation the required pivot angle of the lens plane around the axis a is optimally small, it is not important that, when selecting the position of the axis a, the image B′ of the second scene point P_{SZ2} is not focused. In order to determine the position of the axis a, it is sufficient for example to use the centre of the image area of the second selected scene point P_{SZ2} still unfocused in the image plane E_{B}.

To automatically execute this mentioned second step, the computing unit 37 is programmed so that on the basis of the identification data for the first and the second scene point P_{SZ1} and P_{SZ2} as well as laws of geometry, the position of the first lens plane axis a is determined as well as the necessary degree of tilting of the lens plane E_{O}′ around said axis a, in order to focus the second scene point P_{SZ2} in B′, on the image plane E_{B}. All geometric position values required for this purpose are known.

In a third step, a third scene point P_{SZ3} is selected on the scene point selection unit 35. On the basis of its identification data conveyed to the computing unit 37, the programmed computing unit 37 determines in the lens plane E_{O}′ according to FIG. 7 a second lens plane axis b. This coincides with the intersection line on the one hand from the current—after the focusing of the second image point of the second scene point—lens nodal plane E_{O}′ on the image side and, on the other hand, with the plane defined by the lens nodal point H′ on the image side, first and second image point A′, B′. The computing unit further determines the necessary degree of tilting of the lens plane E_{O}′ around the second lens plane axis b, in order for also the third scene point P_{SZ3} to be focused—C′—in the image plane E_{B}. By pivoting the lens plane E_{O}′ around an axis that runs through the lens nodal point H′ on the image side, and which, because of its vertical position to the aforementioned first lens plane axis a to the plane defined by the mentioned nodal point H′, the image A′ of the first scene point P_{SZ1}, the image B′ of the second scene point P_{SZ2}, is vertical, the image points A′ and B′ remain reproduced in focus and do not shift.

As mentioned, the selected scene points P_{SZ1}, P_{SZ2}, P_{SZ3} can be freely selected in the scene resp. in its image. It is advantageous accordingly to select relevant scene areas.

An embodiment of the inventive method resp. of the inventive camera system according to FIG. 6 is represented with reference to FIG. 7, wherein the lens board is mounted swashplate-like in movable fashion relative to the imager holder. Reverting to FIG. 4, it clearly results that through selective extension lengths specific to the linear actuators and calculated in the computing unit 37, on the one hand the positions of the mentioned lens plane axes a resp. b and on the other hand the extent of the pivoting movements of the lens plane and consequently of the lens board 1 are determined and the drivers of the array 27 are controlled accordingly.

A second embodiment of the inventive method is represented in FIG. 8, executed by a second embodiment of the inventive camera system represented mainly by means of FIG. 6. In this embodiment, the imager holder and thus the image plane E_{B} are modified relative to the lens board. This variant embodiment is thus suitable in particular for cameras for which the lens can be moved at most in a translation movement in the direction of the focal axis, i.e. for example for compact cameras and/or for selecting or modifying the image perspective and/or the image section.

According to FIG. 8, the process in this variant embodiment is as follows:

In the scene point selection unit 35 according to FIG. 6, a first scene point P_{SZ1} is selected. On the basis of the data identifying this scene point, the computing unit 37 determines the necessary translation trajectory from the lens plane E_{O}′ and the image plane E_{B} in the direction of the focal axis A_{F}, in order to focus the scene point P_{SZ1} as D′ in the image plane E_{B}. This is fully analogous to the first step in the first variant of the procedure according to FIG. 7. On the basis of the entered scene point identification data, the computing unit 37 determines the degree of this displacement and consequently controls the drivers according to FIG. 6, in particular the linear actuators according to FIG. 4.

In a second step, a second scene point P_{SZ2} is selected on the scene point selection unit 35. By means of the data identifying this second scene point and the data of the first point D′ focused in the image plane E_{B}, the computing unit 37 determines the position of a first image plane axis c to that this axis c runs through the first image point D′ and is vertical to the connecting line from the image point D′ to the image point E′ of the second selected scene point P_{SZ2} in the image plane E_{B}. In this connection, again in analogy to the first mentioned variant of the procedure, the first image plane axis c is not necessarily vertical to the connecting lines D′, E′ so that it is possible to determine this axis position on the basis of the not yet focused image point E′. The computing unit 37 is programmed so that it determines by means of the identification data of both scene points P_{SZ1} and P_{SZ2} selected so far the position of the image plane axis c as well as the necessary tilting angle with which the image plane E_{B} needs to be pivoted by corresponding tilting of the imager holder in order for the second image point E′ in the image plane E_{B} to be focused. By pivoting the image plane E_{B} around an axis along C running in the image plane, the image point D′ remains focused and does not shift.

In a third step, a third scene point P_{SZ3} is selected on the scene point selection unit 35. With the scene point identification data available so far and additionally the scene point identification data for the scene point P_{SZ3}, the programmed computing unit 37 determines the position of the second image plane axis d in the image plane E_{B}. This second axis d runs through the focused image points D′ and E′ in the image plane. The computing unit 37 further determines the necessary degree of tilting of the image plane E_{B} around this second image plane axis d, so that the scene point P_{SZ3} in F′ in the image plane E_{B} is focused. By pivoting the image plane E_{B} around an axis running through the focused image points D′ and E′, the latter remains reproduced in focus and does not shift.

The Scheimpflug principle is thus also complied with according to this second form of method resp. form of programming of the inventive camera system for any selected scene plane P_{SZ1}, P_{SZ2}, P_{SZ3} whatsoever.

In this variant embodiment too, the scene points P_{D}, P_{E} and P_{F} can be selectively chosen in any place within the selected image section.

Although in connection with the embodiment according to FIG. 6 the selection of the scene points defining the scene plane occurs manually and the necessary adjustment of the camera system by the programmed computing unit takes place automatically, it is of course simply also possible to perform manually in particular the translation displacement until the first image point is focused and, after a preferably computerized determination of the respective axis positions, to manually control the necessary tilting movements required for focusing.

It is possible with the present invention to fulfill the optical conditions for a uncompromising systematical adjustment of the lens plane and/or image plane, regardless of the respective recording situation, of the camera configuration and, generally, independently of the type of lens used and its installation parameters as well as independently of the camera's default settings. No iterative compensation steps are necessary for a systematic adjustment. The scene points can be entered for example by means of a keyboard on the camera system itself or on a computer communicating with the system. Instead of, or additionally to, the keyboard input, it is also possible to enter by mouse click the scene point surface coordinates by means of a graphics corresponding to the image to be recorded or overlaid over the latter. In a similar fashion, commands such as ‘focus’ and ‘move’ can also be entered, also vocally, for which for example it is advantageous to have input devices that enable a sensitive focusing and displacement. Such peripheral devices can be connected over an interface, for example a USB interface, to the system's electronics or to a PC connected with the system. The inventive process achieves a high adjustment security, quality improvement and time saving. In the case of the inventive camera system, possibly desired changes of the image section resp. modifications of the image point positions can be achieved by displacing the imager holder within the image plane and, if necessary or advantageous, e.g. for optimally using the lens image circle diameter, by displacing the lens board within the lens plane. Since these displacements take place within the image plane resp. lens plane, no defocusing will result.

This is in contrast to the state of the art for view camera technology, wherein the correct camera setting can be achieved only approximately, generally in iterative fashion, often with rotations and displacements of the imager holder and lens board around resp. in three axes.

Any desired modifications of the image perspective can be achieved by corresponding rotation of the image plane. In combination with the inventive controlling of the image plane position, it is thus possible to automatically track the required focus compensations. This is possible because on the basis of the inventive process, the current positions of the scene plane and of the lens plane as well as any position of the image plane that might need to be adjusted are known. Because of the Scheimpflug condition to be fulfilled and the lens formula, the new position of the lens plane is automatically calculated and tracked, so that focal plane and image plane are optically conjugated. Furthermore, in the inventive camera system, executed in particular by means of the linear actuators, the orientation of the focal axis can be chosen optimally according to the respective recording situation and camera configuration. An important parameter of the camera configuration is in this respect the actual position of the nodal point on the image side, which depends on the lens type and its installation. Thanks to the driver configuration arranged in parallel, the position and orientation of the tilting axis in the lens plane, which is due to run through the rear nodal point, can be selected independently of the lens type and its installation. It is thus possible to use different lens types and focal distances in a wide range of focal distances with one and the same camera without fittings and modification. No retro-focus lens is required for even the shortest focal distances, which is advantageous with respect to optical performance and cost of the apparatus.

Furthermore, the inventive camera system focuses in particular more accurately with the drivers executed as linear actuators, since the linear actuators act directly in the focal direction and the errors of the individual joints and guides do not add up onto one another. No lever transmissions are necessary.

Furthermore, an inventive camera system can be constructed more rigidly without additional material expenditure. Larger forces as in previously known systems can be transmitted and thus heavier camera components, e.g. lenses, can be supported, moved and positioned. Because of low mass moments of inertia, the inventive camera system can function with a high dynamics while using the same actuation.

Because of the modular structure of the inventive camera system, the same components can be used several times, which affords greater batch sizes in construction with respectively lower production costs. Similarly, the low impact of greater manufacturing tolerances on the functional accuracy of the system will entail lower production and calibration costs.

The inventive camera system can furthermore be used for automatically leveling the camera system, for stereo recordings, macro-scan recordings, panorama recordings, simple lens measurements and as tilt head also for 35 mm cameras, medium-format cameras and video cameras.

1. Camera system having a lens board with a lens determining a lens plane and having an imager holder with an imager determining a film plane, wherein
the lens board and the imager holder are placed in adjustable manner relative to each other and are operatively connected to one another by means of controlled drivers so that they can be displaced in translation in the direction of the focusing axis of the lens relative to one another, characterized in that
a) the lens board can be pivoted around a lens plane axis lying in the lens plane, wherein the position of the lens plane axis can be selected in the lens plane and/or
b) the imager holder can be pivoted around an image plane axis lying in the image plane, wherein the position of the image plane axis can be selected in the image plane.

2. Camera system according to claim 1, characterized in that the lens board or the imager holder is mounted on a system base resp. camera body and in that accordingly, the imager holder resp. the lens board is mounted onto the lens board resp. imager holder.

3. Camera system according to claim 1 or 2, characterized in that the controlled drivers include linear actuators, that are preferably mounted in articulated fashion through ball and socket joints and/or cardan joints on the one hand onto the lens board and on the other hand onto the imager holder.

4. Camera system according to claim 3, characterized in that the joints of the linear actuators form with either the lens board or the imager holder an n-angle and, accordingly, with the imager holder or lens board an m-angle, wherein preferably m=n/2, in that each terminal joint of a linear actuator facing the lens board or the imager holder defines an angle and, accordingly, on the imager holder or lens board two terminal joints facing the latter standard define an angle together, wherein preferably an even number of linear actuators, preferably six linear actuators, are provided.

5. Camera system according to one of the claim 3 or 4, characterized in that the linear actuators include spindle drivers, preferably driven with an electric motor, preferably with a direct current motor or stepping motor, and preferably so that position sensors, preferably including an angular position sensor, preferably an absolute angular position sensor, are operatively connected.

6. Camera system according to one of the claims 1 to 5, characterized in that the camera system includes a scene point selection unit as well as a programmed computing unit, whereon inputs are operatively connected with outputs of the scene point selection unit and outputs of the computing unit are operatively connected with control inputs for the drivers.

7. Camera system according to claim 6, characterized in that the computing unit is programmed in such a manner that the drivers are controlled by entering, into the scene point selection unit, three different scene points so that the three image points of the three scene points are simultaneously reproduced in focus on the image plane.

8. Camera system according to claim 7, characterized in that the computing unit is programmed in such a manner that the drivers are controlled by entering, into the scene point selection unit, a first of the three scene points so that the lens board and the imager holder are displaced in a translation movement along the focal axis of the lens in a relative position to one another in which the image point of the first scene point is represented in focus in the image plane.

9. Camera system according to claim 8, characterized in that the computing unit is programmed in such a manner that the drivers are controlled by entering, in the scene point selection unit, the second of the three scene points so that the lens board is pivoted around a first lens plane axis, running through the lens nodal point on the image side and at least approximately vertical to the plane given by the lens nodal point on the image side as well as the first and second image point of the first and second scene point, into a position in which the second image point is represented in focus in the image plane.

10. Camera system according to claim 9, characterized in that the computing unit is programmed in such a manner that the drivers are controlled by entering, in the scene point selection unit, the third of the three scene points so that the lens board is pivoted around a second lens plane axis, that is formed at least approximately by the intersecting line ahead of the true lens nodal plane on the image side and the plane given by the first and second image point and the lens nodal point on the image side, into a position in which the third image point is also represented in focus in the image plane.

11. Camera system according to claim 8, characterized in that the computing unit is programmed in such a manner that the drivers are controlled by entering, in the scene point selection unit, the second of the three scene points so that the imager holder is pivoted around a first image plane axis, running through the first image point of the first scene point and at least approximately vertical to the straight line given by the first and the second image point of the first and second scene point, into a position in which the second image point is represented in focus in the image plane.

12. Camera system according to claim 11, characterized in that the computing unit is programmed in such a manner that the drivers are controlled by entering, in the scene point selection unit, the third of the three scene points so that the imager holder is pivoted around a second image plane axis running at least approximately through the first and second image point of the first and second scene point, into a position in which the third image point is also represented in focus in the image plane.

13. Method for method for adjusting a camera system so that the Scheimpflug principle can be complied with at least approximately for a selectable scene plane, characterized in that
a) by a relative translation movement of the lens board and of the imager holder, the image of a first, freely selectable scene point is focused, and
b) through a first pivoting movement of the lens board around a first lens plane axis in the lens plane, the image of a second, freely selectable scene point is focused in the image plane without affecting the image of the first scene point;
c) through a second pivoting movement of the lens board around a second lens plane axis in the lens plane, the image of a third, freely selectable scene point is focused, without affecting the images of the first and second scene points;
or in that
b2) through a first pivoting movement of the imager holder around a first image plane axis in the image plane, the image of a second, freely selectable scene point is focused without affecting the image of the first scene point;
c2) through a second pivoting movement of the image holder around a second image plane axis in the image plane, the image of a third, freely selectable scene point is focused, without affecting the images of the first and second scene points.

14. Method according to claim 13, characterized in that the first lens plane axis is selected so that it runs through the lens nodal point on the image side and is at least approximately vertical to the plane given by the lens nodal point on the image side as well as the first and second image points of the first and second scene points.

15. Method according to claim 14, characterized in that the second lens plane axis is selected so that it is formed at least approximately by the intersection line from the current lens nodal plane on the image side and the plane given by the first and second image point and the lens nodal point on the image side.

16. Method according to claim 13, characterized in that the first image plane axis is selected so that it runs through the first image point of the first scene point and is at least approximately vertical to the straight line given by the first and second image point of the first and second scene point.

17. Method according to claim 16, characterized in that the second image plane axis is selected so that it runs through the first and second image point of the first resp. second scene point.

18. Method according to one of the claims 13 to 17, characterized in that the locations of the lens plane axis or image plane axis at least are determined automatically on the basis of the scene point indications.
